(19) United States
(12) Patent Application Publication
(10) Pub. No.: US 2023/0344626 A1
(43) Pub. Date: Oct. 26, 2023

(54) NETWORK CONNECTION MANAGEMENT METHOD AND APPARATUS, READABLE MEDIUM, PROGRAM PRODUCT, AND ELECTRONIC DEVICE

(71) Applicant: Tencent Technology (Shenzhen) Company Limited, Shenzhen (CN)

(72) Inventor: Qian ZHAO, Shenzhen (CN)

(73) Assignee: Tencent Technology (Shenzhen) Company Limited, Shenzhen (CN)

(21) Appl. No.: 18/340,499

(22) Filed: Jun. 23, 2023

Related U.S. Application Data
(63) Continuation of application No. PCT/CN2022/104057, filed on Jul. 6, 2022.

(30) Foreign Application Priority Data
Jul. 9, 2021 (CN) 202110779611.0

(51) Int. Cl. H04L 9/08; H04W 12/08

(52) U.S. Cl. CPC H04L 9/0866; H04L 9/0819; H04W 12/08

(57) ABSTRACT

A method including acquiring a physical address of one or more devices to be accessed, generating an access key corresponding to each physical address the one or more devices, generating, based on the access keys, an association relationship between one or more physical addresses and a corresponding access key, and transmitting the association relationship to an access point device and transmitting the access key included in the association relationship to a corresponding device to be accessed, wherein the access point device verifies, based on the association relationship, an access request initiated by the corresponding device to be accessed based on the access key.

### CROSS-REFERENCE RELATED APPLICATIONS

This application is a continuation application of International Application No. PCT/2022/104057 filed on Jul. 6, 2022, which claims priority to Chinese Patent Application No. 202110779611.0 filed with the China National Intellectual Property Administration on Jul. 9, 2021, the disclosures of each of which being incorporated by reference herein in their entireties.

### FIELD

The disclosure relates to the technical field of computers and communications, and in particular to a network connection management method and apparatus, a computer-readable storage medium, a program product, and an electronic device.

### BACKGROUND

With the development of wireless local area network (WLAN) technology, a large number of stations (STAs) are required, in some application scenarios, to access points (APs), such as in an enterprise-level WLAN, where it is an urgent need to solve the technical problem of effectively realizing network connection management for stations.

### SUMMARY

Embodiments of the disclosure provide a network connection management method and apparatus, a readable medium, a program product, and an electronic device, which help improve the efficiency of network access verification.

Some embodiments provide a network connection management method, performed by an access point management server, the method including: acquiring a physical address of at least one device to be accessed; generating an access key corresponding to each physical address the at least one device; generating, based on the access keys, an association relationship between at least one physical address and a corresponding access key; and transmitting the association relationship to an access point device, and transmitting the access key included in the association relationship to a corresponding device to be accessed, wherein the access point device verifies, based on the association relationship, an access request initiated by the corresponding device to be accessed based on the access key.

Some embodiments provide a network connection management apparatus, the apparatus including: at least one memory configured to store program code; and at least one processor configured to read the program code and operate as instructed by the program code, the program code including: first acquisition code configured to cause at least one of the at least one processor to acquire a physical address of at least one device to be accessed; a first generation code configured to cause at least one of the at least one processor to generate an access key corresponding to each physical address the at least one device; a second generation code configured to cause at least one of the at least one processor to generate, based on the access keys, an association relationship between at least one physical address and a corresponding access key; and first transmission code configured to cause at least one of the at least one processor to transmit the association relationship to an access point device, and transmit the access key included in the association relationship to a corresponding device to be accessed, wherein the access point device verifies, based on the association relationship, an access request initiated by the device to be accessed based on the access key.

Some embodiments provide a non-transitory computer-readable storage medium storing computer code which, when executed by at least one processor, causes the at least one processor to at least implement the network connection management method as described in the foregoing embodiments.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone:

FIG. 1 shows a schematic diagram of WPA/WPA2-PSK authentication.

FIG. 2 shows a schematic diagram of WPA/WPA2-PPSK authentication.

FIG. 3 shows a flowchart for establishing a connection between a STA and an AP.

FIG. 4 shows a schematic diagram of four-way handshake authentication between a STA and an AP.

FIG. 5 shows a schematic diagram of key generation in authentication between a STA and an AP.

FIG. 6 shows a schematic diagram of a configuration interface for portal authentication.

FIG. 7 shows a flowchart of a network connection management method according to some embodiments.

FIG. 8 shows a flowchart of a network connection management method according to some embodiments.

FIG. 9 shows a flowchart of a network connection management method according to some embodiments.

FIG. 10 shows a schematic diagram of a cloud AP scenario according to some embodiments.

FIG. 11 shows a system architecture diagram of a cloud AP scenario according to some embodiments.

FIG. 12 shows a flowchart of a network connection management method according to some embodiments.

FIG. 13 shows an interface diagram of one-click networking according to some embodiments.

FIG. 14 shows a block diagram of a network connection management apparatus according to some embodiments.

FIG. 15 shows a block diagram of a network connection management apparatus according to some embodiments.

FIG. 16 shows a block diagram of a network connection management apparatus according to some embodiments.

FIG. 17 shows a schematic structural diagram of a computer system adapted to implement an electronic device according to some embodiments.

### DETAILED DESCRIPTION

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure and the appended claims.

Furthermore, the features, structures, or characteristics described herein may be combined in one or more embodiments in any suitable manner. In the following description, details are provided to help fully understand the embodiments. However, those skilled in the art will recognize that not all of the details of the embodiments may be used, that one or more specific details may be omitted, or that other methods, elements, apparatuses, and operations may be employed in implementing the technical solutions.

In the following descriptions, related “some embodiments” describe a subset of all possible embodiments. However, it may be understood that the “some embodiments” may be the same subset or different subsets of all the possible embodiments, and may be combined with each other without conflict.

The block diagrams shown in the accompanying drawings are merely functional entities and do not necessarily correspond to physically independent entities. That is, the functional entities may be implemented in a software form (e.g., code), or in one or more hardware units, modules, or integrated circuits, or in different networks and/or processor apparatuses and/or microcontroller apparatuses.

The flowcharts shown in the accompanying drawings are merely exemplary, which do not necessarily include all contents and operations/steps, and are not necessarily performed in the described orders. For example, some operations/steps may be further divided, while some operations/steps may be combined or partially combined. Therefore, an actual execution order may change according to an actual case.

As used herein, “a plurality of” means two or more. When describing an association relationship between related objects, “and/or” means that there may be three relationships, for example, A and/or B, which may include three cases of A alone, A and B together, and B alone. The character “/” generally indicates that the related objects before and after the character are in an “or” relationship.

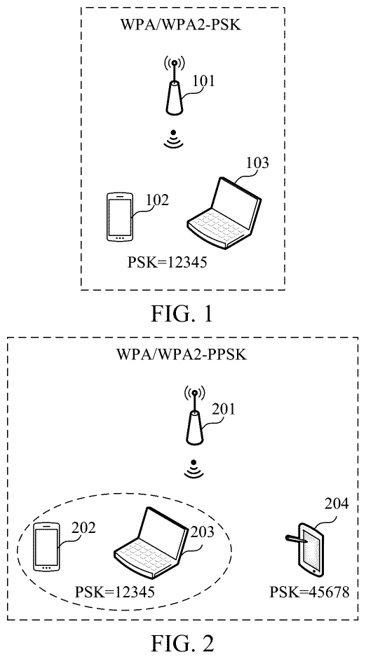

WPA, with a full name of Wi-Fi protected access, has three standards of WPA, WPA2, and WPA3, and is a system for protecting wireless network security. WPA/WPA2-PSK (pre-shared key) is a pre-distributed shared key authentication method, which is more secure in terms of encryption and key verification. As shown in FIG. 1, with WPA/WPA2-PSK authentication, the access key is the same for all stations connected to a specified service set identifier (SSID) of an access point device 101. For example, the PSKs for a station 102 and a station 103 are both “12345”.

WPA/WPA2-PPSK (private PSK) authentication inherits the advantages of WPA/WPA2-PSK authentication of easy deployment, and may provide different pre-shared keys for different stations, which effectively improves the network security. With WPA/WPA2-PPSK authentication, stations connected to the same SSID may have different access keys, and different authorizations may be issued according to different users. If a user has multiple stations, these stations may also connect to the network through the same PPSK account. As shown in FIG. 2, a station 202 and a station 203 connected to the same SSID of an access point device 201 may use the same PSK, while a station 204 may use a different PSK from the station 202 and the station 203.

Regardless of the WPA/WPA2-PSK approach or the WPA/WPA2-PPSK approach, the connection process and key negotiation process between the STA and the AP are consistent.

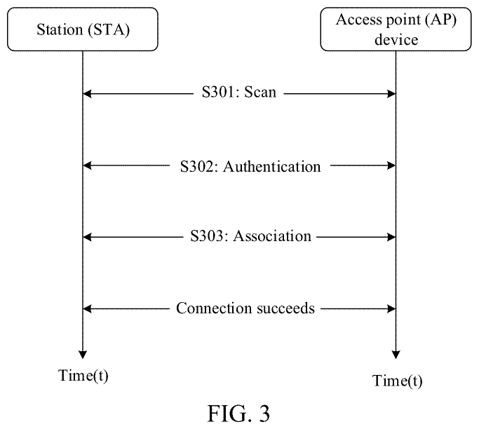

As shown in FIG. 3, the process of establishing the connection between a station (STA) and an access point device (AP) includes the following operations:

Operation S301: Scan.

The STA uses Scanning to search for APs, and as the STA roams to look for and connect to a new AP, the STA may search on each available channel. There are two search methods, including active scanning and passive scanning.

The active scanning means that the STA transmits a probe request frame on each channel (1-13 channels) successively to search for APs with the same SSID as the STA, and scanning is continued if an AP with the same SSID cannot be found. The active scanning is characterized by the ability of quickly finding APs.

The passive scanning means that the STA discovers a network by listening to a beacon frame regularly transmitted by an AP, the beacon frame providing relevant information about the AP and a basic service set (BSS) where it is located. The passive scanning method can reduce the power consumption of the STA although it takes more time to search for APs.

Operation S302: Authentication.

When the STA finds APs with the same SSID as the STA, an AP with a strongest signal is selected in the APs with the matching SSID based on signal strengths of the received APs. Then the process proceeds to the authentication phase, and only a STA with an approved identity authentication can perform wireless access. The authentication methods provided by the AP include: open-system authentication, shared-key authentication, WPA PSK, etc.

The process of open-system authentication is as follows. The STA initiates an authentication request, and an authentication server responds after receiving the request. The process of shared-key authentication is as follows. The STA initiates an authentication request; an authentication server replies with a challenge text after receiving the request; the STA uses a pre-set key to encrypt a plain text and transmits same to the authentication server; and the authentication server uses a pre-set key to decrypt the text and compare same with a pre-set plain text, and the authentication is approved if the two are consistent.

Operation S303: Association.

The process proceeds to the association phase when the AP returns authentication response information to the STA that the STA identity authentication is approved. In the association phase, the STA transmits an association request to the AP and the AP returns an association response to the STA. A roaming issue is involved when the STA moves, and if roaming is within the same network, re-authentication is not required and only re-association is required. When the association between the AP and the STA is completed, the access of the STA is completed, i.e., the connection between the STA and the AP is successful.

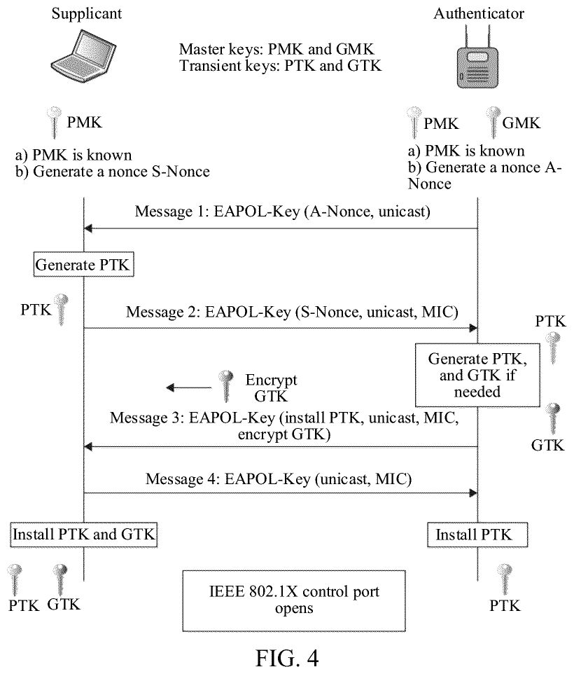

Before data transmission, a four-way handshake based on extensible authentication protocol over LAN (EAPOL) is required between the STA and the AP to generate the required keys. The process is detailed in FIG. 4. The four-way handshake is performed between the STA as a supplicant and the AP as an authenticator.

In the four-way handshake, a message 1 is an EAPOL-Key frame carrying an A-Nonce transmitted from the authenticator to the supplicant via unicast. The A-Nonce is a nonce generated by the authenticator.

After receiving the message 1, as the supplicant has obtained the A-Nonce and the authenticator MAC address (AA) and the supplicant already possesses the pairwise master key (PMK, typically a set of nonces) and the supplicant MAC address (SPA), a pairwise transient key (PTK) can be calculated by the following function:

PTK=PRF(PMK+A-Nonce+S-Nonce+AA+SPA)

The PRF represents a pseudorandom function. The S-Nonce is a nonce generated by the supplicant. The PMK in the formula is set by the supplicant. The resulting PTK includes 3 parts: key confirmation key (KCK), key encryption key (KEK), and temporal key (TK). The KCK is used for computing the integrity of the key generation message, the KEK is used for encrypting the key generation message, and the TK is used for data encryption.

In the four-way handshake, a message 2 is a second EAPOL-Key frame in which the supplicant transmits, after generating the PTK, information such as S-Nonce, message integrity code (MIC, a Hash value calculated for a set of data in need of protection, used for preventing the data from being tampered) to the authenticator. The MIC value in the message 2 is encrypted by key confirmation key (KCK).

After receiving the message 2, the authenticator extracts the S-Nonce in the message 2, and performs a calculation similar to that performed in the supplicant to verify whether the message returned by the supplicant is correct, by performing integrity check on the received MIC and the MIC generated itself. If the message is not correct, i.e., the MIC integrity check fails, indicating that the supplicant PMK is wrong, the whole handshake operation stops.

If the authenticator verifies that the message returned by the supplicant is correct, the authenticator generates PTK and group temporal key (GTK). The GTK is an encryption key used for encrypting multicast and broadcast data streams.

In the four-way handshake, a message 3 is a third EAPOL-Key frame carrying GTK and MIC transmitted from the authenticator to the supplicant after the authenticator generates PTK and GTK. The GTK is encrypted by KEK and the MIC is encrypted by KCK.

After receiving the message 3, the supplicant will also make calculations to determine whether the authenticator PMK is correct. With a correct determination, the supplicant transmits an EAPOL-Key frame to the authenticator for a last time in a message 4 for confirmation. If the authentication is successful, the supplicant and the authenticator both install the keys, where “install” means that the keys are used for encrypting the data. The supplicant installs the PTK and the GTK, and the authenticator installs the PTK.

As the supplicant and the authenticator complete authentication, the control port of the authenticator will be opened, so that data frames in 802.11 format will be transmitted normally. All unicast data frames will be protected with PTK encryption, and all multicast data and broadcast data will be protected with GTK encryption.

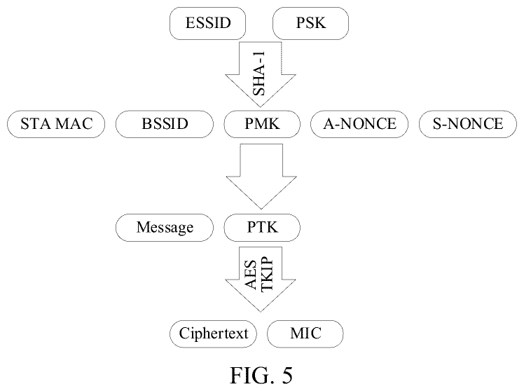

The key generation in authentication is shown in FIG. 5. The PMK is generated by an extended service set identifier (ESSID) and PSK, such as generating the PMK through a secure Hash algorithm 1 (SHA-1 algorithm). The PTK is generated based on the supplicant MAC (i.e., STA MAC), the authenticator MAC (which may be represented by BSSID), PMK, A-Nonce, and S-Nonce acquired in the four-way handshake. The ciphertext and MIC may then be encrypted by the PTK. The encryption may be performed through advanced encryption standard (AES) or temporal key integrity protocol (TKIP).

In an enterprise WLAN, WPA/WPA2-PPSK authentication is used more, so that each user may have an individual key, and configuration and deployment is easy. However, this method needs to store the key of each user on the access point device, i.e., the access point device needs to store a key list separately. If the number of keys in the key list is large, the verification time will be greatly increased in checking a key input by a user. Meanwhile, if the number of keys is large, when a malicious device deliberately inputs a wrong key to attack, the access point device cannot work. It is also difficult to avoid key confusion.

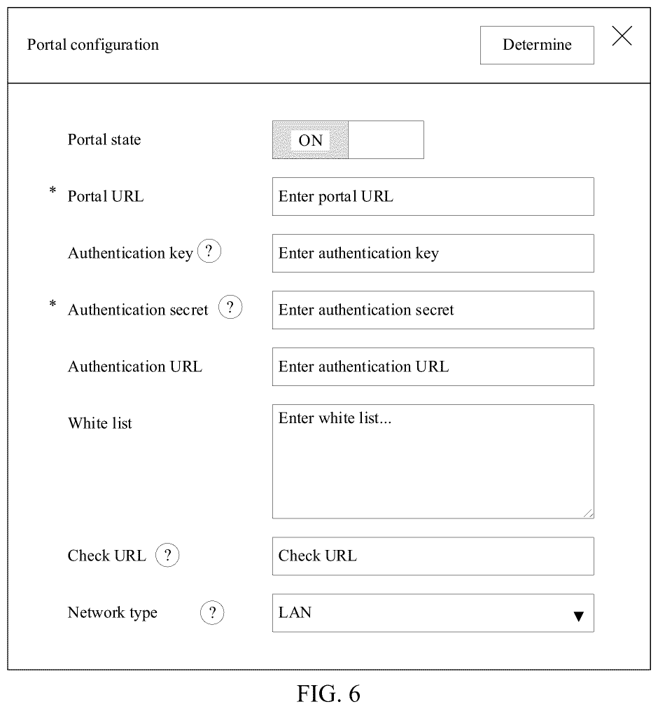

In addition, there is also a portal authentication method in the related art, where portal is a WEB site serving the Internet as a gateway. A Wi-Fi provider needs to configure the portal authentication first. A configuration interface is shown in FIG. 6, and a portal uniform resource locator (URL), an authentication key, an authentication secret, an authentication URL, a white list, a check URL, a network type, and the like are set. After the configuration is completed, the user can connect to a password-free Wi-Fi, and then enter the authenticated user name and password in a portal authentication interface popping up in a browser, so as to actually access the network through the Wi-Fi network. This authentication scheme is cumbersome to operate, and has compatibility problems in portal authentication. Some terminals (such as some types of mobile phones) may fail in popping up the page of portal authentication after getting connected to Wi-Fi, thus leading to failure in authentication.

In consideration of the above problems, the embodiments of the disclosure provide a new network connection management scheme, which can associate an access key of a device to be accessed with a physical address. On this basis, when an access point device verifies an access request, the embodiments can verify whether the physical address of the device to be accessed exists in the association relationship, so as to help avoid the performance of the access point device being affected by a malicious device frequently initiating access requests. In another aspect, when the physical address of the device to be accessed exists in the association relationship, the embodiments can quickly verify an access key included in the access request based on an access key corresponding to the physical address, improving the efficiency of network access verification, and avoiding access key confusion.

The implementation details of the technical solutions of some embodiments are described in detail below.

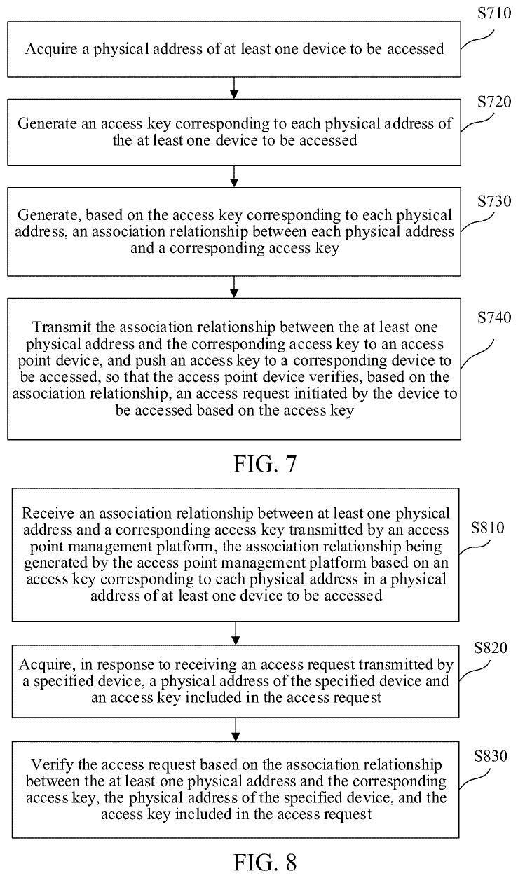

FIG. 7 shows a flowchart of a network connection management method that may be performed by an access point management platform, according to some embodiments. The access point management platform may be a platform for access management, i.e., managing access points. With reference to FIG. 7, the network connection management method includes at least operations S710 to S740 detailed as follows.

In operation S710, a physical address of at least one device to be accessed is acquired.

In some embodiments, the physical address of the device to be accessed may be a media access control (MAC) address. The physical address of the device to be accessed may be directly reported to the access point management platform by the device to be accessed (for example, directly reported to the access point management platform via a mobile communication network), or may be indirectly reported to the access point management platform via other devices.

In some embodiments, an application client is installed on the device to be accessed. The application client may acquire the physical address of the device to be accessed, and then reports the physical address of the device to be accessed to an application server. Then the application server may transmit at least one collected physical address to the access point management platform. Here, the application server may be various devices, such as a server.

In some embodiments, the access point management platform can be embodied in the form of a server, which may be an independent physical server, a server cluster or distributed system formed by a plurality of physical servers, or a cloud server that provides cloud computing services. The device to be accessed may be a smart phone, a tablet computer, a notebook computer, a desktop computer, a smart speaker, a smart watch, a vehicle-mounted terminal, a smart TV, and the like, but is not limited thereto.

In operation S720, an access key corresponding to each physical address the at least one device to be accessed is generated.

In some embodiments, the access point management platform may generate an access key randomly for each device to be accessed, or according to a certain policy. In some embodiments, the access point management platform may generate an access key with a certain rule according to a region where the device to be accessed is located and a device type, for example, an access key beginning with “01” for a device to be accessed in a region 1, and an access key beginning with “02” for a device to be accessed in a region 2, or an access key beginning with “phone” for a phone device, and an access key beginning with “pc” for a computer. In short, operation S720 may generate an access key according to a predetermined rule based on parameters of a device to be accessed (e.g., a region where it is located, a device type).

Some embodiments can generate different access keys for physical addresses of different devices to be accessed, so as to realize one-device-one-key, avoiding access key confusion.

In operation S730, an association relationship between each physical address and a corresponding access key is generated based on the access key corresponding to each physical address.

In some embodiments, after generating a corresponding access key for each physical address, the access key may be stored in association with the physical address to generate an association relationship between at least one physical address and a corresponding access key. In addition, in order to improve the speed of querying access keys in the verification phase, a Hash table may be generated based on the association relationship between at least one access key and a corresponding physical address, thus improving key querying efficiency.

In operation S740, the association relationship between the at least one physical address and the corresponding access key is transmitted to an access point device, and an access key is pushed to a corresponding device to be accessed, so that the access point device verifies, based on the association relationship, an access request initiated by the device to be accessed based on the access key.

In some embodiments, after generating the association relationship between the at least one physical address and the corresponding access key, the access point management platform may transmit the association relationship to the access point device, and may transmit the access key of each device to be accessed to the device to be accessed, for example, directly pushing the access key of the device to be accessed to the device to be accessed via the mobile communication network, or indirectly reporting same to the access point management platform via other devices.

In some embodiments, an application client is installed on the device to be accessed, and the application client can communicate with an application server. In this scenario, the access point management platform can push the association relationship between the at least one physical address and the corresponding access key to the application server, so that the application server can transmit, based on the association relationship, each access key to a device to be accessed corresponding to a physical address associated with the access key.

In summary, some embodiments associate the access key of the device to be accessed with the physical address. On this basis, when an access point device verifies an access request, some embodiments can verify whether the physical address of the device to be accessed exists in the association relationship, so as to help avoid the performance of the access point device being affected by a malicious device frequently initiating access requests. In another aspect, when the physical address of the device to be accessed exists in the association relationship, some embodiments can quickly verify an access key included in the access request based on an access key corresponding to the physical address, improving the efficiency of network access verification, and avoiding access key confusion.

FIG. 7 illustrates the technical solutions of some embodiments from the perspective of an access point management platform, and the technical solutions of some embodiments are described below from the perspective of an access point device.

FIG. 8 shows a flowchart of a network connection management method that may be performed by an access point device, according to some embodiments. With reference to FIG. 8, the network connection management method includes at least operations S810 to S830 detailed as follows.

In operation S810, an association relationship between at least one physical address and a corresponding access key transmitted by an access point management platform is received, the association relationship being generated by the access point management platform based on an access key corresponding to each physical address at least one device to be accessed.

In some embodiments, the process in which the access point management platform generates the association relationship between the at least one physical address and the corresponding access key may refer to preceding embodiments, which will not be repeated.

In operation S820, in response to receiving an access request transmitted by a specified device, a physical address of the specified device and an access key included in the access request are acquired.

In some embodiments, the specified device is a station that requires access to an access point device, which may also be referred to as a device to be accessed. Since the specified device has communicated with the access point device prior to transmitting the access request to the access point device, the physical address of the specified device may have been acquired when the specified device transmitted the access request. The specified device may also carry the physical address thereof again in the access request.

In operation S830, the access request is verified based on the association relationship between the at least one physical address and the corresponding access key, the physical address of the specified device, and the access key included in the access request.

In some embodiments, the access request is determined to be verified successfully in response to determining based on the association relationship between the at least one physical address and the corresponding access key that the physical address of the specified device is associated with the access key included in the access request. The verification process may include: the access point device searching for a corresponding access key in the above association relationship based on the physical address of the specified device, then comparing the searched access key with an access key actively included in the access request, and determining, if the two are consistent, that the access request is verified successfully.

In some embodiments, the access request is rejected in response to determining that the physical address of the specified device is absent in the association relationship. The technical solution of this embodiment can avoid the case where a malicious device frequently initiates connection requests, resulting in that an access point device cannot work normally.

The technical solutions of some embodiments are described below from the perspective of a station.

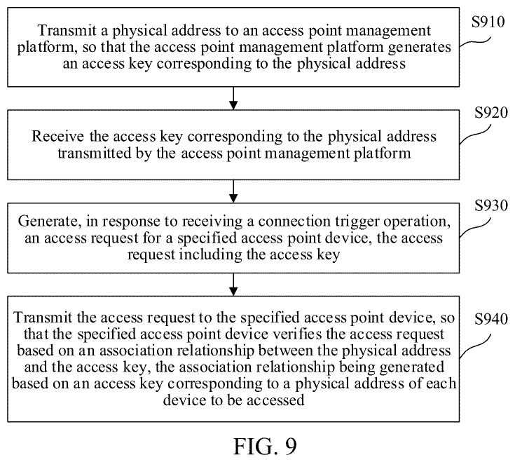

FIG. 9 shows a flowchart of a network connection management method that may be performed by a station, according to some embodiments. A station that requires access to an access point device may also be referred to as a device to be accessed. In other words, the network connection management method may be performed by the device to be accessed. With reference to FIG. 9, the network connection management method includes at least operations S910 to S940 detailed as follows.

In operation S910, a physical address is transmitted to an access point management platform, so that the access point management platform generates an access key corresponding to the physical address.

In some embodiments, an application client running in the station, after establishing a connection with an application server, may transmit the physical address of the station to the application server, so that the application server transmits the physical address to the access point management platform.

In some embodiments, the station may associate user account information in a local application client with a physical address of a device to be accessed running the local application client, which is transmitted to an application server, so that the application server may know a corresponding relationship between the physical address and the user account information, and transmit the physical address to the access point management platform.

In operation S920, the access key corresponding to the physical address transmitted by the access point management platform is received.

In some embodiments, the process in which the access point management platform transmits the access key corresponding to the physical address directly or through the application server may refer to preceding embodiments, which will not be repeated.

In operation S930, in response to receiving a connection trigger operation, an access request is generated for a specified access point device, the access request including the access key.

In some embodiments, the connection trigger operation may be a networking operation triggered on a station by user input, such as clicking a networking button.

In some embodiments, a graphical user interface configured with a network connection trigger control may be presented on the station (in particular, the application client installed on the station). In response to detecting a trigger operation on the network connection trigger control, a connection trigger operation may be determined to be received, so that an access request may be generated based on the access key.

In operation S940, the access request is transmitted to the specified access point device, so that the specified access point device verifies the access request based on an association relationship, the association relationship being used for representing a relationship between each physical address at least one device to be accessed and a corresponding access key.

In some embodiments, the verification process of the access point device may refer to the technical solutions of preceding embodiments, which will not be repeated.

The technical solutions of some embodiments are set forth in preceding embodiments separately from the perspective of an access point management platform, an access point device, and a station. Details of some embodiments are described below from the perspective of interactions among various devices.

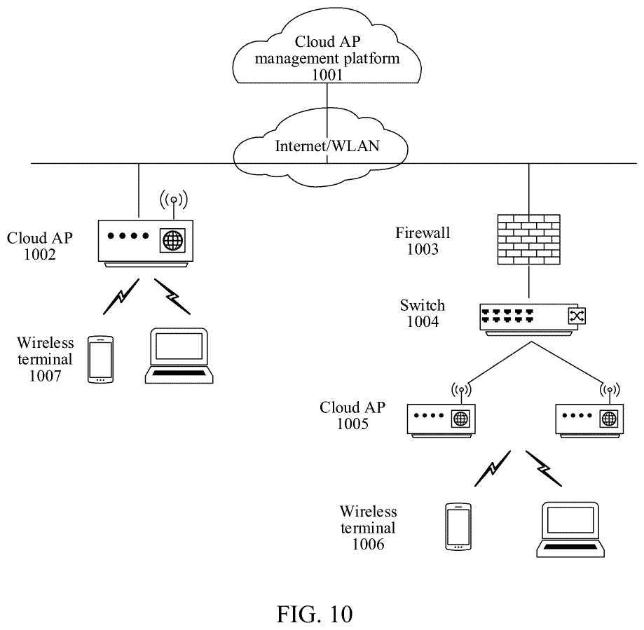

In some embodiments, an access point device may be a cloud AP, where the cloud AP extends the management capability of a local AP to the cloud, and performs unified management on a plurality of cloud APs through the cloud (a cloud AP management platform, i.e., the access point management platform in preceding embodiments), such as configuring a LAN, a wide area network (WAN), and black and white lists, of the cloud AP. A cloud AP scenario is shown in FIG. 10, where a cloud AP management platform 1001 directly communicates with a cloud AP 1002 via Internet or WLAN, or the cloud AP management platform 1001 communicates with a cloud AP 1005 through a firewall 1003 and a switch 1004 via Internet or WLAN. The cloud AP 1005 (1002) is used for communication with a wireless terminal (i.e., the device to be accessed in the preceding text) 1006 (1007).

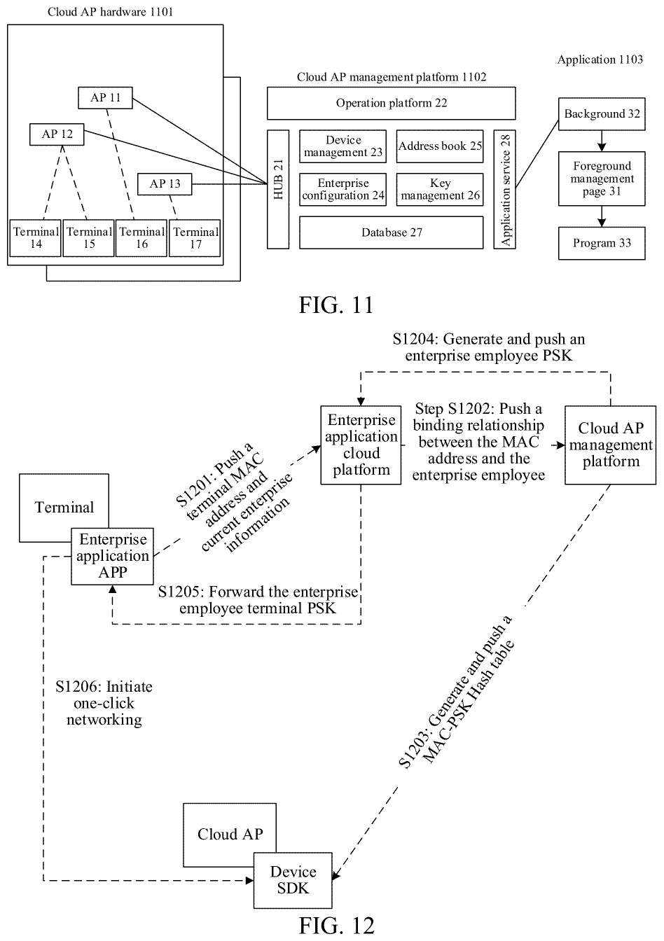

A system architecture of the cloud AP scenario is shown in FIG. 11, which mainly includes three parts: cloud AP hardware 1101, a cloud AP management platform 1102, and an application 1103.

The cloud AP hardware 1101 mainly includes one or more cloud APs (such as 11, 12, and 13), where each cloud AP needs to connect to the cloud AP management platform 1101 (a connection can be performed via a multi-port HUB 21), and receives AP configuration information transmitted from the cloud AP management platform 1101, and at the same time receives key issuing and management of PPSK, and receives and manages connection information on terminals (such as 14, 15, 16, and 17) (i.e., stations).

The cloud AP management platform 1102 includes an operation platform 22, a HUB 21, a device management 23, an enterprise configuration 24, an address book 25, a key management 26, a database 27, an application service 28, etc.

The operation platform 22 is used for managing cloud task scheduling, monitoring abnormal situations, etc. The HUB 21 is responsible for connecting to the cloud AP hardware 1101 and maintaining related heartbeats. The device management 23 is mainly used for managing information about the connected cloud AP. The enterprise configuration 24 is mainly used for managing cloud AP configuration related to each enterprise. The address book 25 is mainly used for recording information of enterprise employees, including mobile phone numbers or account information on instant messaging software, etc. The key management 26 is used for generating, destroying, and updating keys, and at the same time distributing a MAC-PSK Hash table to the enterprise. The application service 28 is used for providing corresponding API (application programming interface) interface information and the like to the application. The database 27 serves as an essential component for persisted storage of data.

The application 1103 mainly refers to an application corresponding to a cloud AP, including a front-end management page (such as a foreground management page 31) and application information, a back-end platform (such as a background 32) and service capabilities, etc. In some embodiments, the application 1103 may be a hosted program, which is a program that exists depending on the host environment (e.g., a program 33), such as an applet, a fast application.

Based on the system architecture shown in FIG. 11, network access management can be implemented through the flow shown in FIG. 12. In some embodiments, the flow including the following operations:

Operation S1201: An enterprise application APP pushes a terminal MAC address and current enterprise information to an enterprise application cloud platform. Here, the enterprise application cloud platform may be, for example, the application server described above.

The enterprise application APP may be an APP developed separately for a certain enterprise or may be a public platform for all enterprises. If the enterprise application APP is a public platform for all enterprises, an enterprise user needs to create enterprise information on the public platform, bind a cloud AP of the enterprise with the enterprise information, and configure SSID, for example, on the cloud AP.

When the enterprise application APP is installed on a terminal of an enterprise employee and enters the enterprise to which the enterprise employee belongs, the enterprise application APP may collect the MAC address of the terminal and then push the information to the enterprise application cloud platform.

Operation S1202: The enterprise application cloud platform pushes a binding relationship between the MAC address and the enterprise employee to the cloud AP management platform. Here, the cloud AP management platform may be, for example, an access point management platform.

In some embodiments, the enterprise employee may be information such as an employee number or a name of the enterprise employee, or may be information such as an account name of the enterprise employee in the enterprise application APP. In some embodiments, the enterprise application cloud platform may merely push the MAC address to the cloud AP management platform, and maintain the binding relationship between the MAC address and the enterprise employee locally.

Operation S1203: The cloud AP management platform generates and pushes a MAC-PSK Hash table to the device SDK of the AP. Here, the MAC-PSK Hash table is used for indicating association relationships between physical addresses and access keys.

In some embodiments, the cloud AP management platform may generate a one-device-one-key MAC-PSK Hash table (i.e., one access key for one access device) based on the MAC address pushed by the enterprise application cloud platform, and transmit the MAC-PSK Hash table to the device software development Kit (SDK) of the cloud AP.

Operation S1204: The cloud AP management platform generates and pushes an enterprise employee terminal PSK to the enterprise application cloud platform.

In some embodiments, the cloud AP management platform may push the association relationship between the PSK and the MAC address to the enterprise application cloud platform, so that the enterprise application cloud platform issues the PSK according to the MAC address.

In some embodiments, operation S1204 and operation S1203 may not be performed in a particular order; operation S1203 may be performed first, and then operation S1204 may be performed; operation S1204 may be performed first, and then operation S1203 may be performed; alternatively, operation S1203 and operation S1204 may be performed simultaneously.

Operation S1205: The enterprise application cloud platform forwards the enterprise employee PSK to the enterprise application APP.

In some embodiments, the enterprise application cloud platform pushes the PSK to a corresponding enterprise application APP based on the MAC address reported by the enterprise application APP according to the association relationship between the MAC address and the PSK. After acquiring the association relationship between the MAC address and the PSK, the enterprise application cloud platform may actively push the PSK to the corresponding enterprise application APP, or may transmit the PSK to the corresponding enterprise application APP in response to receiving an access key acquisition request transmitted from the enterprise application APP.

Operation S1206: The user device initiates one-click networking at the enterprise application APP.

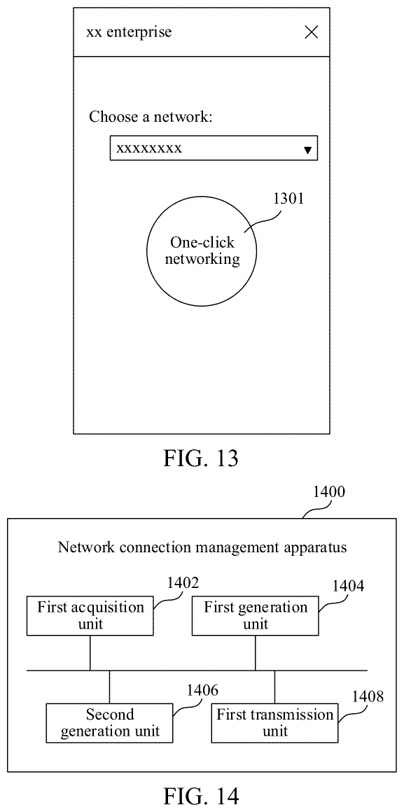

As shown in FIG. 13, in some embodiments, a “one-click networking” control 1301 can be displayed in the enterprise application APP. The user may click the “one-click networking” control 1301 after selecting the enterprise network to be connected, so that the enterprise application APP on the terminal will push the PSK to the cloud AP device. Since the cloud AP device will also acquire the MAC address of the terminal during the communication with the enterprise application APP, the cloud AP device will perform quick verification according to the MAC-PSK Hash table.

A corresponding PSK can be retrieved in the MAC-PSK Hash table according to the MAC address of the terminal. Then, it is verified whether the PSK is consistent with that pushed by the enterprise application APP, and if so, the verification is determined to be successful. This scheme greatly reduces the verification time as compared with a scheme in which the AP stores a key list separately and verifies whether the PSK pushed by the enterprise application APP exists in the key list by retrieving the key in the key list. Meanwhile, since the AP needs to verify whether the MAC address exists in the MAC-PSK Hash table, an access request initiated by a device with an illegal MAC address may be directly rejected as well, thus avoiding the performance of the access point device being affected by a malicious device frequently initiating access requests while avoiding access key confusion.

The following describes some apparatus embodiments that may be used for performing the network connection management method of the foregoing embodiments. For details not disclosed in the apparatus embodiments, reference may be made to the foregoing embodiments of the network connection management method.

FIG. 14 shows a block diagram of a network connection management apparatus that may be embodied within an access point management platform, according to some embodiments.

With reference to FIG. 14, a network connection management apparatus 1400 according to some embodiments includes: a first acquisition unit 1402, a first generation unit 1404, a second generation unit 1406, and a first transmission unit 1408.

The first acquisition unit 1402 is configured to acquire a physical address of at least one device to be accessed. The first generation unit 1404 is configured to generate an access key corresponding to each physical address the at least one device to be accessed. The second generation unit 1406 is configured to generate, based on the access key corresponding to each physical address, an association relationship between at least one physical address and a corresponding access key. The first transmission unit 1408 is configured to transmit the association relationship to an access point device, and transmit an access key to a corresponding device to be accessed, so that the access point device verifies, based on the association relationship, an access request initiated by the device to be accessed based on the access key.

In some embodiments, based on the aforementioned solutions, the first acquisition unit 1402 is configured to: receive a physical address of at least one device to be accessed transmitted by an application server, where the physical address of the at least one device to be accessed is transmitted to the application server by an application client running on the at least one device to be accessed.

In some embodiments, based on the aforementioned solutions, the first transmission unit 1408 is configured to: transmit the association relationship between the at least one physical address and the corresponding access key to the application server, so that the application server transmits, based on the association relationship, each access key to a device to be accessed corresponding to a physical address associated with the access key.

In some embodiments, based on the aforementioned solutions, the first generation unit 1404 is configured to: generate, based on each physical address, a corresponding access key, where access keys generated for physical addresses of different devices to be accessed are different.

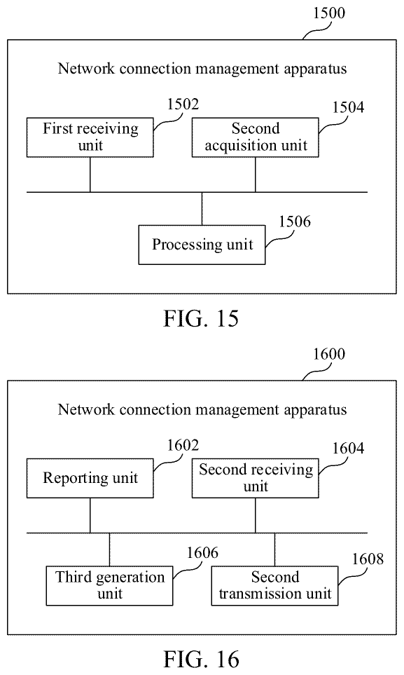

FIG. 15 shows a block diagram of a network connection management apparatus that may be embodied within an access point device, according to some embodiments.

With reference to FIG. 15, a network connection management apparatus 1500 according to some embodiments includes: a first receiving unit 1502, a second acquisition unit 1504, and a processing unit 1506.

The first receiving unit 1502 is configured to receive an association relationship between at least one physical address and a corresponding access key transmitted by an access point management platform, the association relationship being generated by the access point management platform based on an access key corresponding to each physical address at least one device to be accessed. The second acquisition unit 1504 is configured to acquire, in response to receiving an access request transmitted by a specified device, a physical address of the specified device and an access key included in the access request. The processing unit 1506 is configured to verify the access request based on the association relationship, the physical address of the specified device, and the access key included in the access request.

In some embodiments, based on the aforementioned solutions, the processing unit 1506 is configured to: determine, in response to determining based on the association relationship that the physical address of the specified device is associated with the access key included in the access request, that the access request is verified successfully.

In some embodiments, based on the aforementioned solutions, the processing unit 1506 is configured to: reject the access request in response to determining that the physical address of the specified device is absent in the association relationship.

FIG. 16 shows a block diagram of a network connection management apparatus that may be embodied within a station, according to some embodiments.

With reference to FIG. 16, a network connection management apparatus 1600 according to some embodiments includes: a reporting unit 1602, a second receiving unit 1604, a third generation unit 1606, and a second transmission unit 1608.

The reporting unit 1602 is configured to transmit a physical address to an access point management platform, so that the access point management platform generates an access key corresponding to the physical address. The second receiving unit 1604 is configured to receive the access key corresponding to the physical address transmitted by the access point management platform. The third generation unit 1606 is configured to generate, in response to receiving a connection trigger operation, an access request for a specified access point device, the access request including the access key. The second transmission unit 1608 is configured to transmit the access request to the specified access point device, so that the specified access point device verifies the access request based on an association relationship, the association relationship being used for representing a relationship between each physical address at least one device to be accessed and a corresponding access key.

In some embodiments, based on the aforementioned solutions, the reporting unit 1602 is configured to: associate user account information in a local application client with a physical address of a device to be accessed running the local application client, which is reported to an application server, so that the application server transmits the physical address to the access point management platform.

In some embodiments, based on the aforementioned solutions, the network connection management apparatus 1600 further includes: a determination unit, configured to present a graphical user interface configured with a network connection trigger control, and determine, in response to detecting a trigger operation on the network connection trigger control, that a connection trigger operation is received.

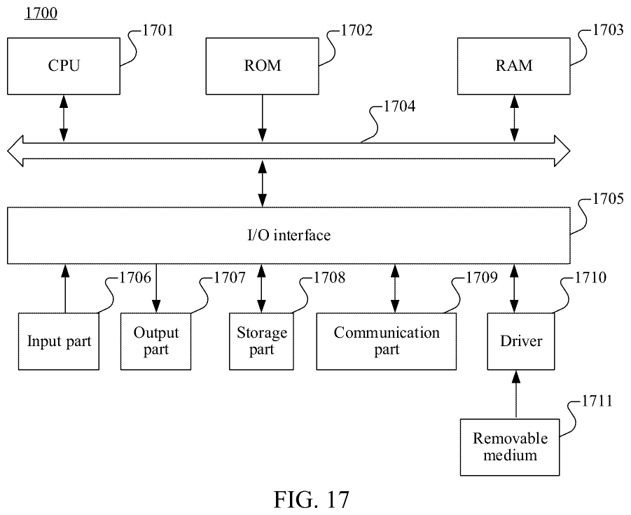

FIG. 17 shows a schematic structural diagram of a computer system adapted to implement an electronic device according to some embodiments.

The computer system 1700 of the electronic device shown in FIG. 17 is merely an example and does not pose any limitation on the functionality or scope of use of the embodiments described herein.

As shown in FIG. 17, the computer system 1700 includes a central processing unit (CPU) 1701, which may perform various suitable actions and processing based on a program stored in a read-only memory (ROM) 1702 or a program loaded from a storage part 1708 into a random access memory (RAM) 1703, for example, perform the method described in the foregoing embodiments. In the RAM 1703, various programs and data required for system operation are further stored. The CPU 1701, the ROM 1702, and the RAM 1703 are connected to each other via a bus 1704. An input/output (I/O) interface 1705 is further connected to the bus 1704.

The following components are connected to the I/O interface 1705: an input part 1706 including a keyboard, a mouse, etc.; an output part 1707 including a cathode ray tube (CRT), a liquid crystal display (LCD), a loudspeaker, etc.; a storage part 1708 including a hard disk, etc.; and a communication part 1709 including a network interface card such as a local area network (LAN) card, a modem, etc. The communication part 1709 performs communication processing through a network such as the Internet. A driver 1710 is also connected to the I/O interface 1705 as needed. A removable medium 1711, such as a magnetic disk, an optical disk, a magneto-optical disk, or a semiconductor memory is installed on the drive 1710 as needed, so that a computer program read therefrom is installed in the storage part 1708 as needed.

In some embodiments, the process described above with reference to the flowchart may be implemented as a computer software program. For example, some embodiments include a computer program product including a computer program carried in a computer-readable medium. The computer program includes a computer program used for performing the method shown in the flowchart. In such embodiments, the computer program may be downloaded and installed over a network via the communication part 1709, and/or installed from the removable medium 1711. When the computer program is executed by the central processing unit (CPU) 1701, various functions defined in the system are executed.

The computer-readable medium illustrated in some embodiments can be a computer-readable signal medium or a computer-readable storage medium or any combination thereof. The computer-readable storage medium may be, for example, but is not limited to, an electric, magnetic, optical, electromagnetic, infrared, or semi-conductive system, apparatus, or device, or any combination thereof. The computer-readable storage medium may include, but are not limited to: an electrical connection having one or more wires, a portable computer disk, a hard disk, a random access memory (RAM), a read-only memory (ROM), an erasable programmable read-only memory (EPROM), a flash memory, an optical fiber, a portable compact disc read-only memory (CD-ROM), an optical storage device, a magnetic storage device, or any suitable combination thereof. In some embodiments, the computer-readable storage medium may be any tangible medium containing or storing a program, and the program may be used by or used in combination with an instruction execution system, an apparatus, or a device. In some embodiments, the computer-readable signal medium may include a data signal propagated in a baseband or as part of a carrier, in which a computer-readable program is carried. A data signal propagated in such a way may assume a plurality of forms, including, but not limited to, an electromagnetic signal, an optical signal, or any suitable combination thereof. The computer-readable signal medium may be any further computer-readable medium in addition to a computer-readable storage medium. The computer-readable medium may transmit, propagate, or transmit a program that is used by or used in combination with an instruction execution system, an apparatus, or a device. The computer program included on the computer-readable medium may be transmitted over any suitable medium including, but not limited to: wireless, wired, or any suitable combination thereof.

The flowcharts and block diagrams in the accompanying drawings illustrate architectures, functions, and operations of possible embodiments according to a system, a method, and a computer program product of various embodiments. Each block in a flowchart or a block diagram may represent a module, a program segment, or a part of code. The module, the program segment, or the part of code includes one or more executable instructions for implementing specified logic functions. In some embodiments, the functions indicated in the blocks may occur in different orders than those indicated in the drawings. For example, two blocks shown in succession may actually be performed substantially in parallel, and the two blocks may sometimes be performed in a reverse sequence, depending on the functions involved. Each block in a block diagram or a flowchart and a combination of blocks in the block diagram or the flowchart may be implemented by using a dedicated hardware-based system configured to perform a specified function or operation, or may be implemented by using a combination of dedicated hardware and computer instructions.

A related unit described in some embodiments may be implemented in software, or may be implemented in hardware, and the unit described can also be embodied in a processor. The names of units do not constitute a limitation on the elements themselves in some cases.

Some embodiments further provide a computer-readable medium. The computer-readable medium may be included in the electronic device described in the foregoing embodiments, or may exist alone without being assembled into the electronic device. The computer-readable medium carries one or more programs, the one or more programs, when executed by the electronic device, causing the electronic device to implement the method described in the foregoing embodiments.

Although several modules or units of a device configured to perform actions are discussed in the foregoing detailed description, such division is not mandatory. In some embodiments, the features and functions of two or more modules or units described above may be embodied in one module or unit. On the contrary, the features and functions of one module or unit described above may be further divided to be embodied by a plurality of modules or units.

Through the foregoing descriptions of the various embodiments, a person skilled in the art may readily understand that the example embodiments described herein may be implemented by software, or may be implemented by combining software and necessary hardware. Therefore, the technical solutions may be embodied in a software product. The software product may be stored in a non-volatile storage medium (which may be a CD-ROM, a USB flash drive, a mobile hard disk, and the like), or a non-transient storage medium, or on the network, including several instructions for instructing a computing device (which may be a personal computer, a server, a touch terminal, a network device, and the like) to perform the methods according to some embodiments.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure.

What is claimed is:

1. A method performed by an access point management server, the method comprising:
acquiring a physical address of at least one device to be accessed;
generating an access key corresponding to each physical address of the at least one device;
generating, based on the access keys, an association relationship between at least one physical address and a corresponding access key; and
transmitting the association relationship to an access point device, and transmitting the access key included in the association relationship to a corresponding device to be accessed,
wherein the access point device verifies, based on the association relationship, an access request initiated by the corresponding device to be accessed based on the access key.

2. The method of claim 1, wherein the acquiring comprises:
receiving the physical address of the at least one device to be accessed from an application client running on the at least one device to be accessed through an application server.

3. The method of claim 2, wherein transmitting the access key to the corresponding device to be accessed comprises:
transmitting the association relationship between the at least one physical address and the corresponding access key to the application server,
wherein, based on the association relationship, the application server transmits each access key to a corresponding device to be accessed that corresponds to a physical address associated with the access key.

4. The method according to claim 1, wherein generating the access key comprises:
generating, based on each physical address, a corresponding access key,
wherein access keys for physical addresses of different devices to be accessed are different.

5. The method according to claim 1, further comprising:
generating, based on the association relationship, a Hash table for representing the association relationship.

6. The method according to claim 1, wherein generating the access key comprises:
generating the access key according to a predetermined rule based on a location of the at least one device to be accessed or a type of device of the at least one device to be accessed.

7. The method according to claim 3, further comprising:
generating, based on the association relationship, a Hash table for representing the association relationship.

8. A apparatus comprising:
at least one memory configured to store program code; and
at least one processor configured to read the program code and operate as instructed by the program code, the program code comprising:
first acquisition code configured to cause at least one of the at least one processor to acquire a physical address of at least one device to be accessed;
first generation code configured to cause at least one of the at least one processor to generate an access key corresponding to each physical address the at least one device;
second generation code configured to cause at least one of the at least one processor to generate, based on the access keys, an association relationship between at least one physical address and a corresponding access key; and
first transmission code configured to cause at least one of the at least one processor to transmit the association relationship to an access point device, and transmit the access key included in the association relationship to a corresponding device to be accessed,
wherein the access point device verifies, based on the association relationship, an access request initiated by the corresponding device to be accessed based on the access key.

9. The apparatus of claim 8, wherein the first acquisition code is further configured to cause at least one of the at least one processor to:
receive the physical address of the at least one device to be accessed from an application client running on the at least one device to be accessed through an application server.

10. The apparatus according to claim 9, wherein the first transmission code is further configured to cause at least one of the at least one processor to:
transmit the association relationship between the at least one physical address and the corresponding access key to the application server,
wherein, based on the association relationship, the application server transmits each access key to a corresponding device to be accessed that corresponds to a physical address associated with the access key.

11. The apparatus according to claim 8, wherein the first generation unit is further configured to cause at least one of the at least one processor to:
generate, based on each physical address, a corresponding access key, wherein access keys for physical addresses of different devices to be accessed are different.

12. The apparatus according to claim 8, wherein the first generation code is further configured to cause at least one of the at least one processor to:
generate, based on the association relationship, a Hash table for representing the association relationship.

13. The apparatus according to claim 8, wherein the first generation code is further configured to cause at least one of the at least one processor to:
generate the access key according to a predetermined rule based on a location of the at least one device to be accessed or a type of device of the at least one device to be accessed.

14. The apparatus according to claim 10, further comprising:
generating, based on the association relationship, a Hash table for representing the association relationship.

15. A non-transitory computer-readable storage medium storing computer code which, when executed by at least one processor, causes the at least one processor to at least,
acquire a physical address of at least one device to be accessed;
generate an access key corresponding to each physical address of the at least one device;
generate, based on the access keys, an association relationship between at least one physical address and a corresponding access key; and
transmit the association relationship to an access point device, and transmit the access key included in the association relationship to a corresponding device to be accessed,
wherein the access point device verifies, based on the association relationship, an access request initiated by the corresponding device to be accessed based on the access key.

16. The non-transitory computer-readable storage medium of claim 15, wherein the acquiring comprises:
receiving the physical address of the at least one device to be accessed from an application client running on the at least one device to be accessed through an application server.

17. The non-transitory computer-readable storage medium of claim 16, wherein the transmit an access key to a corresponding device to be accessed comprises:
transmitting the association relationship between the at least one physical address and the corresponding access key to the application server,
wherein based on the association relationship, the application server transmits each access key to a corresponding device to be accessed that corresponds to a physical address associated with the access key.

18. The non-transitory computer-readable storage medium according to claim 15, wherein the generate an access key comprises:
generating, based on each physical address, a corresponding access key,
wherein access keys for physical addresses of different devices to be accessed are different.

19. The non-transitory computer-readable storage medium according to claim 15, wherein the computer code further causes at least one of the at least one processor to:
generate, based on the association relationship, a Hash table for representing the association relationship.

20. The non-transitory computer-readable storage medium according to claim 17, wherein the generate the access key comprises:
generating the access key according to a predetermined rule based on a location of the at least one device to be accessed or a type of device of the at least one device to be accessed.
